(19) United States
(12) Patent Application Publication
(10) Pub. No.: US 2024/0239348 A1
(43) Pub. Date: Jul. 18, 2024

(54) METHOD FOR THE MULTISTAGE FUSION OF MEASUREMENT DATA

(71) Applicant: Robert Bosch GmbH, Stuttgart (DE)

(72) Inventors: Matthias Mauro, Neckarsulm (DE); Martin Rabel, Yokohama-shi (JP); Dirk Huelsebusch, Stuttgart (DE); Ingmar Berger, Muehlacker (DE); Junyi Tao, Stuttgart (DE)

(21) Appl. No.: 18/559,116

(22) PCT Filed: Jul. 11, 2022
(86) PCT No.: PCT/EP2022/069290

§ 371 Date: Nov. 6, 2023

(30) Foreign Application Priority Data
Sep. 6, 2021 (DE) 10 2021 209 817.7

(51) Int. Cl. B60W 40/02; B60W 50/08

(52) U.S. Cl. CPC B60W 40/02; B60W 50/08

(57) ABSTRACT

A method for the fusion of measurement data from a plurality of on-board sensors. Measurement data ascertained by a first group of sensors are received by a first controller or by a first module, and are fused to form a first environmental model. The measurement data are used with a first functional safety rating by the first environmental model, or the first environmental model is created based on the measurement data. Measurement data ascertained by at least one second group of sensors are received by at least one second controller or by at least one second module, and are fused to form at least one second environmental model. The measurement data of the second group are used with a second functional safety rating by the second environmental model, or the at least one second environmental model is created based on the measurement data of the second group.

### FIELD

The present invention relates to a method for the fusion of measurement data from a plurality of on-board sensors, to a controller, a computer program, and a machine-readable storage medium.

### BACKGROUND INFORMATION

Representation of the vehicle environment is usually required to implement various driving assistance functions and emergency braking functions. Depending on the characteristic and performance requirement, measurement data of a plurality of sensors are received and fused together for this purpose. For example, for a current EU NCAP 2020 requirement, a one radar one video (1R1V) fusion is needed to combine the more accurate measurement methods of the radar sensor with the better angular quality and the classification capabilities of a video sensor. The installation position is in this case central on the vehicle front and the coverage range is oriented in the driving direction.

Emergency braking functions and driving assistance functions have different functional safety requirements defined in different ASIL ratings. For example, emergency braking functions require ASIL-B ratings since they can be used directly without driver confirmation and can result in dangerous situations as a result of erroneous activations. Usually, the central fusion of measurement data of the on-board sensors takes place in the controller, in which the corresponding functional algorithms are also calculated or the environmental models are created. However, the different functional safety ratings are derived from the functional algorithms all the way to the environmental model, always resulting in the more safety-relevant ASIL-B for the latter. There are two options for implementing functions with a different functional safety rating: Either all sensor data contributing to the environmental model likewise fulfill the highest requirement, for example for ASIL-B, or different environmental models with different ratings are calculated in parallel. However, this increases the development and validation effort for the sensors or the resource requirements of the controller.

German Patent Application No. DE 10 2017 206 123 A1 describes a method for the fusion of data from various sensors of a vehicle within the framework of object recognition. The measured variables ascertained from measurement data of different sensors are linked and checked for plausibility in a subsequent processing step.

### SUMMARY

An object of the present invention includes providing a method for the fusion of measurement data that lowers the power demand of a controller.

This object may be achieved by features of the present invention. Advantageous embodiments of the present invention are disclosed herein.

According to one aspect of the present invention, a method for the fusion of measurement data from a plurality of on-board sensors is provided. According to an example embodiment of the present invention, measurement data ascertained by a first group of sensors are received by a first controller or by a first module of a central control unit. Subsequently, the measurement data of the first group of sensors are fused to form a first environmental model or are optionally fused prior to utilization within the framework of the first environmental model.

The at least two groups of sensors may alternatively or additionally also be designed as a group of sensors or as one sensor, which can provide two measurement data sets or at least two groups of measurement data. In this case, the measurement data and/or the sensors in the corresponding groups can also overlap.

The measurement data of the first group of sensors are used with a first functional safety rating by the first environmental model. Alternatively, the first environmental model is created with the first functional safety rating based on the measurement data of the first group.

Furthermore, measurement data ascertained by at least one second group of sensors are received by at least one second controller or by at least one second module of the central control unit and are fused to form at least one second environmental model.

A two-stage measurement data fusion thus takes place, in which the second environmental model in the second stage is based on the data or results of the first environmental model and on the measurement data of the second group. The second environmental model can thus be formed from the first environmental model and from measurement data of further sensors.

Depending on the configuration, the first environmental model can also depend on measurement data of the second group of sensors.

Preferably, the measurement data of the second group of sensors are used with a second functional safety rating by the second environmental model. Alternatively, the at least one second environmental model is created with the second functional safety rating, based on the measurement data of the second group.

Preferably, the first functional safety rating differs from the at least one second functional safety rating. The first rating is preferably higher than the second rating. Thus, for example, the first rating can be designed as ASIL-B, ASIL-C or ASIL-D, and the second rating can be defined as ASIL-A or QM in accordance with ISO 26262.

In addition to the first environmental model, according to an example embodiment of the present invention, a plurality of second environmental models can be used, which respectively have different functional safety ratings. In this case, environmental models and measurement data with a common rating can be processed on a common controller or a common module of the central control unit.

The method allows for a multistage fusion of measurement data of different sensors with a different functional safety rating. For example, a two-stage fusion allows only an ASIL-B-relevant environmental model to be generated in a first step and its output combined with further QM sensor data to be fused in a separate second step. This results, for example, in two environmental models which can be used in the respective functions with a different ASIL rating. For example, an ASIL-B-rated environmental model can receive measurement data from sensors at the lowest latency, as a result of which only the additional computing effort for processing the sensors of the second group arises in the second environmental model, which is rated as QM, for example.

The principle of multistage fusion can be transferred to any number of stages as long as the different environmental models are connected with a decreasing functional safety rating.

According to a further aspect of the present invention, at least one controller is provided, wherein the controller is configured to perform the method. The controller may, for example, be an on-board controller, an off-board controller, or an off-board server unit, such as a cloud system.

According to an example embodiment of the present invention, the controller can be designed as a central control unit with one or different modules for processing different environmental models. Alternatively, the controller may be designed as a first controller or as a second controller.

In addition, according to one aspect of the present invention, a computer program is provided, which comprises instructions that, when the computer program is executed by a computer or a controller, cause the computer or controller to perform the method according to the present invention. According to a further aspect of the present invention, a machine-readable storage medium is provided, on which the computer program according to the present invention is stored.

According to an example embodiment of the present invention, the vehicle can in this case be operated in an assisted, partially automated, highly automated and/or fully automated, or driverless, manner in accordance with the BASt standard.

In one exemplary embodiment of the present invention, the measurement data ascertained by the first group of sensors are received with a functional safety of ASIL-B or higher. As a result, the measurement data are received at a minimum latency by the first controller or by the first module of the central control unit so that particularly safety-critical functions can be implemented.

According to a further embodiment of the present invention, at least one output of the first environmental model is provided to the second environmental model. As a result of this measure, measurement data already processed in the first environmental model no longer have to be processed by the second environmental model, which reduces the power demand required by the controllers or the central control unit.

According to a further exemplary embodiment of the present invention, the first environmental model is created with a higher functional safety rating than the second environmental model. Preferably, the first environmental model and further second environmental models are created in the form of a cascade with increasing gradation of functional safety. Separate processing of measurement data and environmental models with a different functional safety rating can thereby be realized. The parallel processing of all measurement data can in this case be omitted if the environmental models with a lower rating obtain the results or outputs from environmental models with a higher ASIL rating as an additional input.

According to a further exemplary embodiment of the present invention, the first environmental model is created with at least an ASIL-B functional safety rating and the second environmental model is created with an ASIL-A or a QM functional safety rating. Thus, for example, video sensors and radar sensors directed in the driving direction can be processed particularly optimally within the framework of the ASIL-B rating, and the further radar sensors arranged on the vehicle, such as corner radars, can be processed by an environmental model with a QM functional safety rating.

According to a further exemplary embodiment of the present invention, the output of the first environmental model is provided to at least one first driving assistance function, and the output of the second environmental model is provided to at least one second driving assistance function. The first driving assistance function may, for example, be designed as an emergency brake assist system. The at least one second driving assistance function may, for example, be designed as a lane departure warning system, a lane-change assistant, a turn-off assistant, and the like. In this case, the second driving assistance function can likewise benefit from the outputs of the first environmental model supplied to the second environmental model.

Preferred exemplary embodiments of the present invention are described in more detail below with reference to highly simplified schematic representations.

### BRIEF DESCRIPTION OF THE DRAWINGS

FIG. 1 shows a schematic sensor arrangement for illustrating a method according to the present invention, according to one example embodiment of the present invention.

FIG. 2 shows a further, schematic sensor arrangement for illustrating a method according to the present invention, according to one example embodiment of the present invention.

FIG. 3 shows a schematic diagram for illustrating a method according to the present invention, according to a further example embodiment.

### DETAILED DESCRIPTION OF EXAMPLE EMBODIMENTS

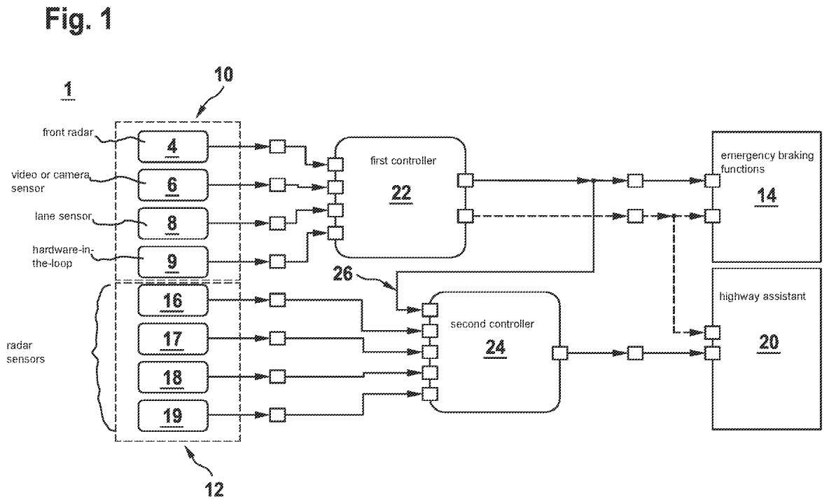

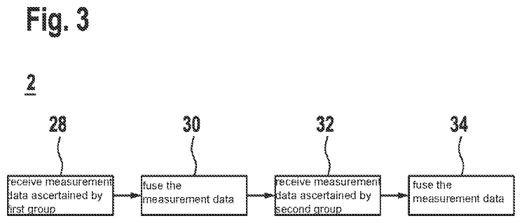

FIG. 1 shows a schematic sensor arrangement 1 for illustrating a method 2 according to the present invention, which is described in more detail in FIG. 3, according to one embodiment.

The sensor arrangement 1 can, for example, be an on-board sensor arrangement that comprises a front radar 4, a video sensor, or camera sensor, 6 oriented in the driving direction, and video-based lane sensors 8. These sensors 4, 6, 8 form a first group 10 of sensors, which can generate measurement data at a particularly low latency and forward them for further utilization. By means of the sensors 4, 6, 8 associated with the first group 10, safety-critical driving functions, such as emergency braking functions 14, which require an ASIL-B or a higher functional safety rating, can be realized. In addition, a so-called HIL (hardware-in-the-loop) 9 can be provided in the first group 10 in order, for example, to implement pre-processing of the measurement data of the sensors 4, 6, 8.

Provided in addition to the first group 10 of sensors is also a second group 12 of sensors which operate at a lower functional safety rating, for example ASIL-A or QM. In the exemplary embodiment shown, the second group 12 comprises four radar sensors 16, 17, 18, 19, which can be arranged at four corner positions of a vehicle (not described in more detail). For example, the measurement data of the sensors 16, 17, 18, 19 of the second group 12 can be used to implement a highway assistant 20 as a driving assistance function.

In the exemplary embodiment shown, the measurement data of the sensors of the first group 10 are fused within the framework of an ASIL-B rating in a first controller 22. In addition, the measurement data of the sensors of the second group 12 are fused within the framework of a lower QM rating in a second controller 24.

The first controller 22 utilizes the measurement data to create or execute a first environmental model. A corresponding output 26 of the first environmental model is supplied as an input to a second environmental model, which is created or executed by the second controller 24. In addition, the second controller 24 also uses the measurement data of the sensors of the second group 12 as inputs for the second environmental model, as a result of which the highway assistant 20 can benefit from the measurement data of the sensors of the first group 10 and of the first environmental model.

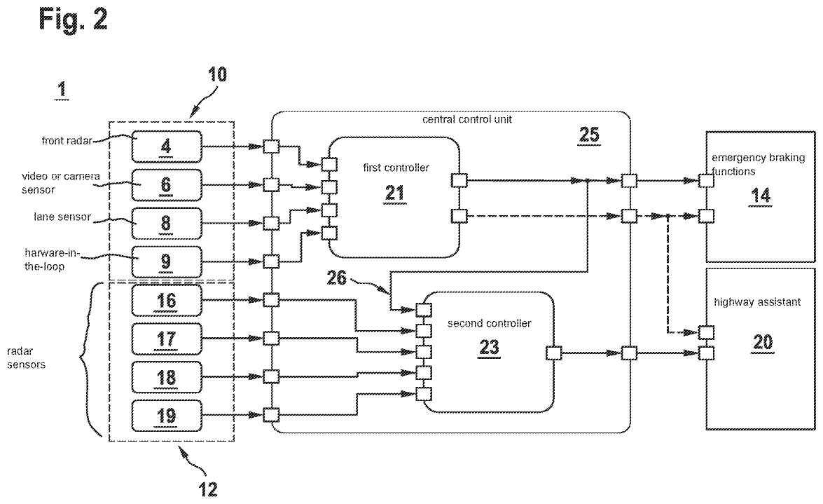

Analogously to FIG. 1, FIG. 2 shows a schematic sensor arrangement 1 for illustrating a method 2 according to the present invention, according to a further embodiment. In contrast to FIG. 1, the first environmental model is created or executed by a first module 21 of a central control unit 25, and the second environmental model is created or executed by a second module 23 of the central control unit 25.

FIG. 3 shows a schematic diagram for illustrating a method 2 according to the present invention, according to a further embodiment. The method 2 is used for the fusion of measurement data of a plurality of on-board sensors 4, 6, 8, 16, 17, 18, 19.

Measurement data ascertained by a first group 10 of sensors are received by a first controller 22 or by a first module 21 of a central control unit 25. (Step 28). Subsequently, the measurement data of the first group 10 of sensors 4, 6, 8 are fused to form a first environmental model or are optionally fused prior to utilization within the framework of the first environmental model. (Step 30).

The measurement data of the first group 10 of sensors 4, 6, 8 are used with a first functional safety rating, for example ASIL-B, by the first environmental model. Alternatively, the first environmental model is created with the first functional safety rating, based on the measurement data of the first group 10.

Furthermore, measurement data ascertained by at least one second group 10 of sensors 16, 17, 18, 19 are received by at least one second controller 24 or by at least one second module 23 of the central control unit 25 (step 32) and are fused to form at least one second environmental model (step 34).

Preferably, the measurement data of the second group 12 of sensors are used with a second functional safety rating, for example QM or ASIL-A, by the second environmental model. Alternatively, the at least one second environmental model is created with the second functional safety rating, based on the measurement data of the second group 12.

1-9. (canceled)

10. A method for fusion of measurement data from a plurality of on-board sensors by at least one controller, the method comprising the following steps:
receiving, by a first controller or by a first module of a central control unit, measurement data ascertained by a first group of sensors, and fusing the measurement data ascertained by the first group of sensors to form a first environmental model, wherein the measurement data of the first group of sensors are used with a first functional safety rating by the first environmental model, or the first environmental model is created based on the measurement data of the first group of sensors; and
receiving, by at least one second controller or by at least one second module of the central control unit, measurement data ascertained by at least one second group of sensors, and fusing the measurement data ascertained by the least one second group of sensors to form at least one second environmental model, wherein the measurement data of the second group of sensors are used with a second functional safety rating by the second environmental model, or the at least one second environmental model is created based on the measurement data of the second group of sensors.

11. The method according to claim 10, wherein the measurement data ascertained by the first group of sensors are received with a functional safety of ASIL-B or higher.

12. The method according to claim 10, wherein at least one output of the first environmental model is provided to the second environmental model.

13. The method according to claim 10, wherein the first environmental model is created with a higher functional safety rating than the second environmental model, wherein the first environmental model and further second environmental models are created in the form of a cascade with increasing gradation of functional safety.

14. The method according to claim 13, wherein the first environmental model is created with at least an ASIL-B functional safety rating, and the second environmental model is created with an ASIL-A or a QM functional safety rating.

15. The method according to claim 10, wherein output of the first environmental model is provided to at least one first driving assistance function, and output of the second environmental model is provided to at least one second driving assistance function.

16. A controller configured for fusion of measurement data from a plurality of on-board sensors by at least one controller, the controller configured to:
receive, by a first controller or by a first module of a central control unit, measurement data ascertained by a first group of sensors, and fusing the measurement data ascertained by the first group of sensors to form a first environmental model, wherein the measurement data of the first group of sensors are used with a first functional safety rating by the first environmental model, or the first environmental model is created based on the measurement data of the first group of sensors; and
receive, by at least one second controller or by at least one second module of the central control unit, measurement data ascertained by at least one second group of sensors, and fusing the measurement data ascertained by the least one second group of sensors to form at least one second environmental model, wherein the measurement data of the second group of sensors are used with a second functional safety rating by the second environmental model, or the at least one second environmental model is created based on the measurement data of the second group of sensors.

17. A non-transitory machine-readable storage medium on which is stored a computer program for fusion of measurement data from a plurality of on-board sensors by at least one controller, the computer program, when executed by a computer, causing the computer to perform the following steps:
receiving, by a first controller or by a first module of a central control unit, measurement data ascertained by a first group of sensors, and fusing the measurement data ascertained by the first group of sensors to form a first environmental model, wherein the measurement data of the first group of sensors are used with a first functional safety rating by the first environmental model, or the first environmental model is created based on the measurement data of the first group of sensors; and
receiving, by at least one second controller or by at least one second module of the central control unit, measurement data ascertained by at least one second group of sensors, and fusing the measurement data ascertained by the least one second group of sensors to form at least one second environmental model, wherein the measurement data of the second group of sensors are used with a second functional safety rating by the second environmental model, or the at least one second environmental model is created based on the measurement data of the second group of sensors.
